(19) United States
(12) Patent Application Publication
(10) Pub. No.: US 2025/0385329 A1
(43) Pub. Date: Dec. 18, 2025

(54) BATTERY MODULE

(71) Applicants: HYUNDAI MOTOR COMPANY, Seoul (KR); KIA CORPORATION, Seoul (KR)

(72) Inventors: Gyung Hoon Shin, Hwaseong-si (KR); Hae Woong Jung, Hwaseong-si (KR)

(73) Assignees: HYUNDAI MOTOR COMPANY, Seoul (KR); KIA CORPORATION, Seoul (KR)

(21) Appl. No.: 19/222,262

(22) Filed: May 29, 2025

(30) Foreign Application Priority Data
Jun. 12, 2024 (KR) 10-2024-0076566
Apr. 16, 2025 (KR) 10-2025-0049581

(51) Int. Cl. H01M 10/48; G01K 1/08; G01K 1/143; G01K 1/16; H01M 10/42

(52) U.S. Cl. CPC H01M 10/486; G01K 1/08; G01K 1/143; G01K 1/16; H01M 10/425

(57) ABSTRACT

A battery module includes a battery stack including a plurality of batteries stacked along a first axis, and a sensing module coupled to a side of the battery stack. The sensing module may include a substrate part provided above the battery stack, and a temperature sensing part connected to a side of the substrate part and having a side provided to be in contact with the battery stack.

### CROSS-REFERENCE TO RELATED APPLICATION

This application claims priority to and the benefit of Korean Patent Application No. 10-2024-0076566 filed in the Korean Intellectual Property Office on Jun. 12, 2024, and Korean Patent Application No. 10-2025-0049581 filed in the Korean Intellectual Property Office on Apr. 16, 2025, the entire contents of which are incorporated herein by reference.

### TECHNICAL FIELD

The present disclosure relates to a battery module.

### BACKGROUND ART

In the case of battery modules mounted in electric vehicles, performance of batteries in the battery modules is important. Additionally it is very important to detect states of the battery modules and appropriately control the battery modules based on their states. To this end, components for measuring temperatures, voltages, and the like of the batteries in the battery modules are required. Therefore, in the related art, sensors for measuring temperatures and voltages of the batteries are mounted in the battery modules.

In order for the sensor configured to measure a temperature to function properly, the sensor configured to measure a temperature needs to always be kept tightly attached to or in close contact with the battery. However, in the related art, there is a problem in that the sensor cannot be reliably tightly attached to the battery, for example, so as to be maintained in close contact with the battery, because of swelling, physical impact, or the like caused or occurring during a process of using the battery module.

### SUMMARY

The present disclosure has been made in an effort to allow a sensor to be stably or reliably tightly attached to a battery in a battery module, for example, such that the sensor is maintained in close contact with the battery, thereby allowing the sensor to stably or reliably measure a temperature of the battery module.

In order to achieve the above-mentioned object, one aspect of the present disclosure provides a battery module including: a battery stack including a plurality of batteries stacked along a first axis (i.e., in a leftward/rightward direction); a sensing module coupled to a side of the battery stack, in which the sensing module includes: a substrate part provided above the battery stack; and a temperature sensing part connected to a side of the substrate part and having a side provided to be in contact with the battery stack.

The substrate part may include: a first substrate extension region extending along a second axis (i.e., in a forward/rearward direction); and a second substrate extension region connected to an end of the first substrate extension region with respect to the second axis and extending along the first axis, and the temperature sensing part may be in contact with an end of the second substrate extension region with respect to the first axis.

The first substrate extension region may include a folded section having a shape folded along the second axis.

The second substrate extension region may include: a first portion connected to a first end of the first substrate extension region with respect to the second axis and extending along the first axis; and a second portion connected to a second end of the first substrate extension region with respect to the second axis and extending along the first axis, and the temperature sensing part may include: a first temperature sensing part provided to be in contact with an end of the second portion of the first substrate extension region with respect to the first axis; and a second temperature sensing part provided to be in contact with an end of the second portion of the second substrate extension region with respect to the first axis.

The first temperature sensing part may include a first portion connected to one end of the second portion of the first substrate extension region with respect to the first axis, the second temperature sensing part may include a first portion connected to one end of the second portion of the second substrate extension region with respect to the first axis, and a height along a third axis of a region in which the first portion of the first temperature sensing part is in contact with the battery stack may be different from a height along a third axis of a region in which the first portion of the second temperature sensing part is in contact with the battery stack.

The first temperature sensing part may further include: a first portion connected to a first end of the first portion of the second substrate extension region with respect to the first axis; and a second portion connected to a second end of the first portion of the second substrate extension region with respect to the first axis, and a height along a third axis of a region in which the first portion of the first temperature sensing part is in contact with the battery stack may be different from a height along a third axis of a region in which the second portion of the first temperature sensing part is in contact with the battery stack.

The second temperature sensing part may further include a second portion connected to the second end of the second portion of the second substrate extension region with respect to the first axis, and a height along the third axis of a region in which the first portion of the second temperature sensing part is in contact with the battery stack may be different from a height along the third axis of a region in which the second portion of the second temperature sensing part is in contact with the battery stack.

The temperature sensing part may further include: a connection member provided to be partially in contact with an upper surface of the second substrate extension region; a sensor member connected to one side of the connection member and provided to be in contact with the battery stack; and a foam member at least partially provided outside the sensor member with respect to the first axis.

The sensor member may be embedded in the foam member.

The battery module may further include side plates provided at two opposite sides of the battery stack with respect to the first axis, in which the sensor member and the foam member are inserted between the side plate and the battery stack.

The battery module may further include: a surface pressure generation member provided between the battery stack and the side plate, in which the surface pressure generation member is provided to overlap the sensor member and the foam member with respect to the second axis.

An accommodation groove, which accommodates a part of the connection member, may be formed in an inner surface of the side plate.

The accommodation groove may be formed in an end region of the side plate with respect to the second axis.

The battery module may further include: an end cap member provided at one side of the battery stack with respect to the second axis; and a signal receiving board fixed to one side of the end cap member with respect to the second axis, in which the substrate part includes a substrate-board connection region having a shape extending forward from an end of the second substrate extension region with respect to the second axis and then bent downward, and in which the substrate-board connection region is connected to the signal receiving board.

The battery module may further include: a holder member provided at one side of the battery stack with respect to the second axis; and a busbar coupled to the holder member, in which the substrate part includes a substrate-busbar connection region having a shape extending forward from an end of the second substrate extension region with respect to the second axis and then bent downward, and in which the substrate-busbar connection region is electrically connected to the busbar.

A seating groove having a shape recessed downward may be formed in an upper surface of the holder member, and a part of the second substrate extension region may be seated in the seating groove.

The battery module may further include: an insulation member configured to cover a region in which the second substrate extension region and the connection member are in contact with each other.

The substrate part may be a flexible printed circuit board (FPCB).

According to the present disclosure, the sensor may be stably or reliably tightly attached to the battery in the battery module, such that the temperature of the battery module may be stably or reliably measured.

### BRIEF DESCRIPTION OF THE DRAWINGS

FIG. 1 is a perspective view of a battery module according to one example of the present disclosure.

FIG. 2 is a perspective view of a sensing module provided in the battery module according to one example of the present disclosure.

FIG. 3 is an enlarged view illustrating a temperature sensing part of the sensing module illustrated in FIG. 2 according to one example of the present disclosure.

FIG. 4 is a view illustrating a horizontal cross-sectional structure of the battery module according to one example of the present disclosure.

FIG. 5 is a perspective view of a side plate provided in the battery module according to one example of the present disclosure.

FIG. 6 is a view illustrating a state in which the temperature sensing part is seated in an accommodation groove formed in the side plate in FIG. 5 according to one example of the present disclosure.

FIG. 7 is an enlarged view illustrating a connection structure between the sensing module and a busbar in the battery module according to one example of the present disclosure.

FIG. 8 is an enlarged view illustrating a region in which a substrate part and the temperature sensing part are connected and illustrating the surroundings of the region in the battery module according to one example of the present disclosure.

### DETAILED DESCRIPTION

Hereinafter, a battery module according to the present disclosure is described. When a component, unit, controller, device, element, apparatus or the like of the present disclosure is described as having a purpose or performing an operation, function, or the like, the component, unit, controller, device, element or apparatus should be considered herein as being “configured to” meet that purpose or perform that operation or function. Each component, unit, controller, device, element, apparatus, and the like may separately embody or be included with a processor and a memory, such as a non-transitory computer readable media, as part of the apparatus.

### Battery Module

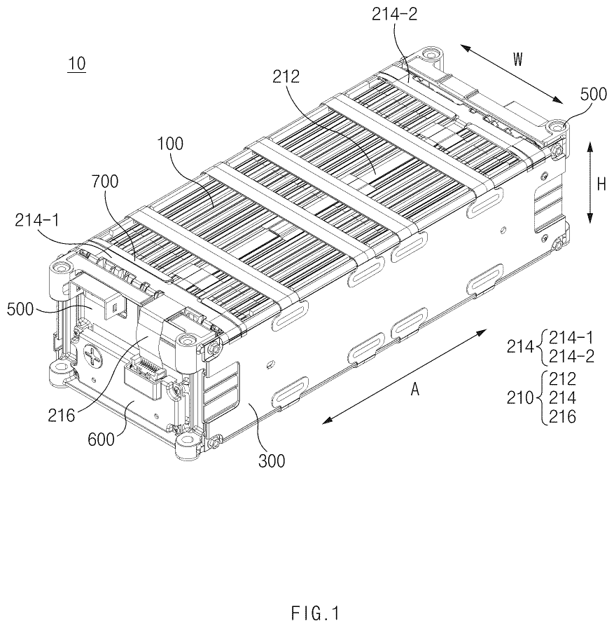

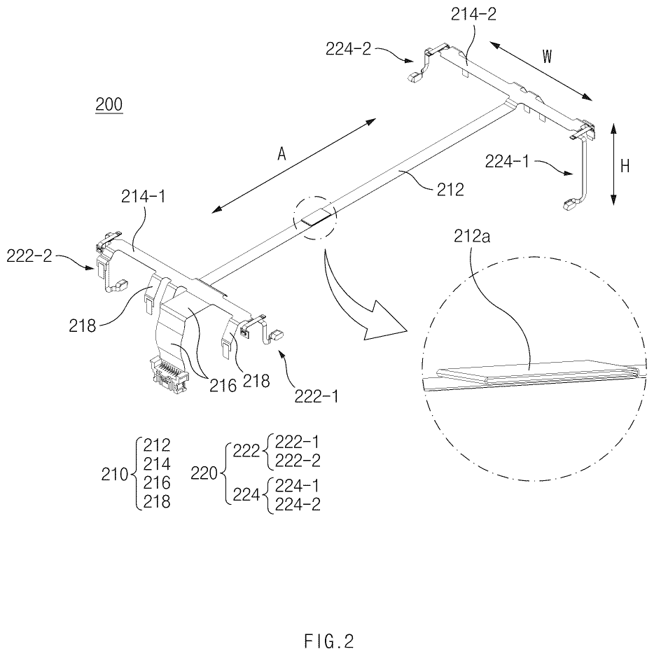

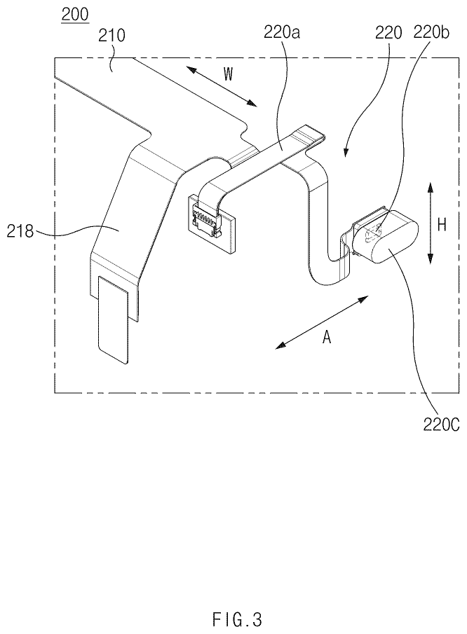

FIG. 1 is a perspective view of a battery module according to the present disclosure. FIG. 2 is a perspective view of a sensing module provided in the battery module according to the present disclosure. FIG. 3 is an enlarged view illustrating a temperature sensing part of the sensing module illustrated in FIG. 2.

With reference to FIGS. 1-3, a battery module 10 according to the present disclosure may include a battery stack 100 including a plurality of batteries stacked along a first axis or in a leftward/rightward (or width) direction W, and a sensing module 200 coupled to one side of the battery stack 100.

According to the present disclosure, the sensing module 200 may be configured to detect, in real time, a state of the battery module including the battery stack by measuring a temperature and a voltage of the battery stack 100. In particular, according to the present disclosure, the sensing module 200 may be characterized by being easily assembled during a process of manufacturing the battery module 10 and stably or reliably tightly attached to the battery stack, for example, so as to be reliably maintained in close contact with the battery stack, after being completely assembled.

More specifically, the sensing module 200 may include a substrate part 210 provided above the battery stack 100, and a temperature sensing part 220 connected to one side of the substrate part 210. The temperature sensing part 220 may have one side provided to be in contact with the battery stack 100. More specifically, the temperature sensing part 220 may be provided as a plurality of temperature sensing parts 220. The plurality of temperature sensing parts 220 may be connected to one side of the substrate part 210. More particularly, the substrate part 210 may be a flexible printed circuit board (FPCB).

The substrate part 210 may be divided into a plurality of regions. More specifically, the substrate part 210 may include a first substrate extension region 212 extending along a second axis or in a forward/rearward (or length) direction A of the battery module 10, and a second substrate extension region 214 connected to end(s) of the first substrate extension region 212 based on or with respect to the second axis or the forward/rearward direction A. The second substrate region 214 may extend along the first axis or in the leftward/rightward direction W. More particularly, a width of the first substrate extension region 212 along the first axis or in the leftward/rightward direction W may be smaller than a width of the battery stack along the first axis or in the leftward/rightward direction W. In this case, the temperature sensing part 220 may be in contact with an end of the second substrate extension region 214 based on or with respect to the first axis or the leftward/rightward direction W. The temperature sensing part 220 may be electrically connected to the second substrate extension region 214.

As illustrated in FIG. 2, the first substrate extension region 212 may include a folding or folded section 212a having a shape folded along the second axis or in the forward/rearward direction A. The folded section 212a may be configured to accommodate for a tolerance (e.g., change in length) of the battery module 10 along the second axis or in the forward/rearward direction A during the process of manufacturing the battery module 10. In a case in which an actual length of the battery module 10 along the first axis or in the forward/rearward direction A is larger than a designed length of the battery module 10 along the first axis or in the forward/rearward direction A during the process of manufacturing the battery module 10, the folded section 212a may be unfolded, and a length of the first substrate extension region 212 along the first axis or in the forward/rearward direction A may be increased in accordance with a tolerance or variation in length of the battery module 10.

As illustrated in FIGS. 1 and 2, the second substrate extension region 214 may include a first portion 214-1 of the second substrate extension region 214 connected to one end (e.g., a first end) of the first substrate extension region 212 based on or with respect to the second axis or the forward/rearward direction A and extending along the first axis or in the leftward/rightward direction W, and a second portion 214-2 of the second substrate extension region 214 connected to the other end (e.g., a second end) of the first substrate extension region 212 based on or with respect to the second axis or the forward/rearward direction A and extending along the first axis or in the leftward/rightward direction W. It may be understood that the section including the first portion 214-1 of the second substrate extension region 214, the second portion 214-2 of the second substrate extension region 214, and the first substrate extension region 212 has an approximate ‘H’ shape.

With continued reference to FIGS. 2 and 3, the temperature sensing part 220 may include a first temperature sensing part 222 provided to be in contact with an end of the first portion 214-1 of the second substrate extension region 214 based on or with respect to the first axis or the leftward/rightward direction W, and a second temperature sensing part 224 provided to be in contact with an end of the second portion 214-2 of the second substrate extension region 214 based on or with respect to the first axis or the leftward/rightward direction W.

More specifically, the first temperature sensing part 222 may include a first portion 222-1 of the first temperature sensing part 222 connected to one end (e.g., a first end) of the first portion 214-1 of the second substrate extension region 214 with respect to the first axis or the leftward/rightward direction W, and a second portion 222-2 of the first temperature sensing part 222 connected to the other end (e.g., a second end) of the first portion 214-1 of the second substrate extension region 214 with respect to the first axis or the leftward/rightward direction W. In addition, the second temperature sensing part 224 may further include a first portion 224-1 of the second temperature sensing part 224 connected to one end (e.g., a first end) of the second portion 214-2 of the second substrate extension region 214 with respect to the first axis or the leftward/rightward direction W, and a second portion 224-2 of the second temperature sensing part 224 connected to the other end (e.g., a second end) of the second portion 214-2 of the second substrate extension region 214 with respect to the first axis or the leftward/rightward direction W.

More specifically, according to the present disclosure, the first portion 222-1 of the first temperature sensing part 222 and the second portion 222-2 of the first temperature sensing part 222 may be in contact with one side (e.g., a first side) end region of the battery stack 100 with respect to the second axis or the forward/rearward direction A, and the first portion 224-1 of the second temperature sensing part 224 and the second portion 224-2 of the second temperature sensing part 224 may be in contact with the other side (e.g., a second side) end region of the battery stack 100 with respect to the second axis or the forward/rearward direction A. This is based on the fact that the temperature of portion(s) of the battery stack 100 disposed in the vicinity of (e.g., at, near) the end of the battery stack 100 with respect to the second axis or the forward/rearward direction A, which is a region in which a busbar described below and an electrode lead protruding from the battery in the battery stack 100 are disposed, is relatively high.

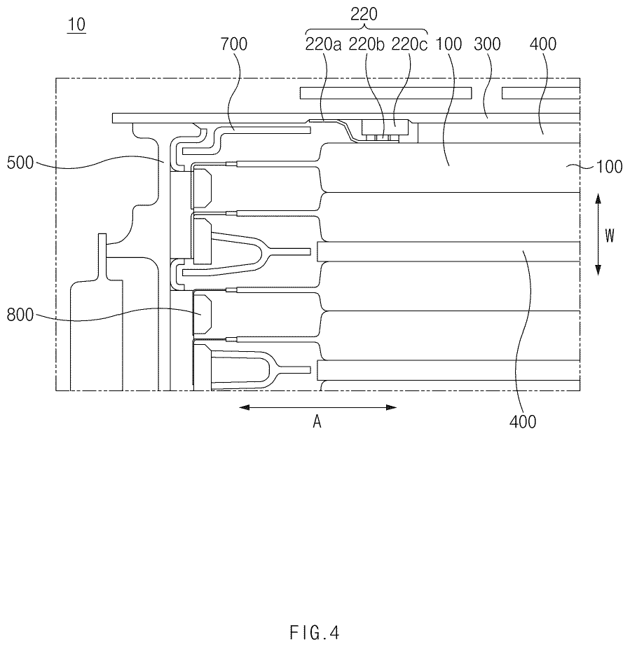

FIG. 4 is a view illustrating a horizontal cross-sectional structure of the battery module according to the present disclosure.

With reference to FIGS. 2 and 4, a height along a third axis or in an upward/downward direction H of a region in which the first portion 222-1 of the first temperature sensing part 222 is in contact with the battery stack 100 may be different from a height along the third axis or in the upward/downward direction H in a region in which the first portion 224-1 of the second temperature sensing part 224 is in contact with the battery stack 100. In addition, the position along the third axis or the height in the upward/downward direction H of the region in which the first portion 222-1 of the first temperature sensing part 222 is in contact with the battery stack 100 may be different from the position along the third axis or a height in the upward/downward direction H of a region in which the second portion 222-2 of the first temperature sensing part 222 is in contact with the battery stack 100. In addition, the position along the third axis or the height in the upward/downward direction H of the region in which the first portion 224-1 of the second temperature sensing part 224 is in contact with the battery stack 100 may be different from the position along the third axis or a height in the upward/downward direction H of a region in which the second portion 224-2 of the second temperature sensing part 224 is in contact with the battery stack 100. In this case, the temperature sensing part 220 may measure temperatures of various regions of the battery stack 100 in real time.

Referring back to FIGS. 2, 3, and 4, the temperature sensing part 220 may further include a connection member 220a provided to be partially in contact with an upper surface of the second substrate extension region 214, a sensor member 220b connected to one side of the connection member 220a and provided to be in contact with the battery stack 100, and a foam member 220c at least partially provided outside the sensor member 220b with respect to the first axis or the leftward/rightward direction W. The foam member 220c may be configured to press the sensor member 220b toward the battery stack 100 while physically protecting the sensor member 220b. The foam member 220c may be made of a material that may be reversibly transformed in shape by an external force. More particularly, as illustrated in FIG. 4, the sensor member 220b may be embedded in the foam member 220c.

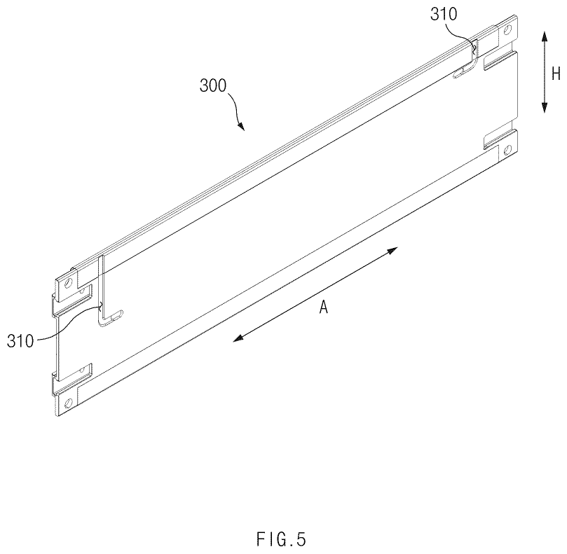

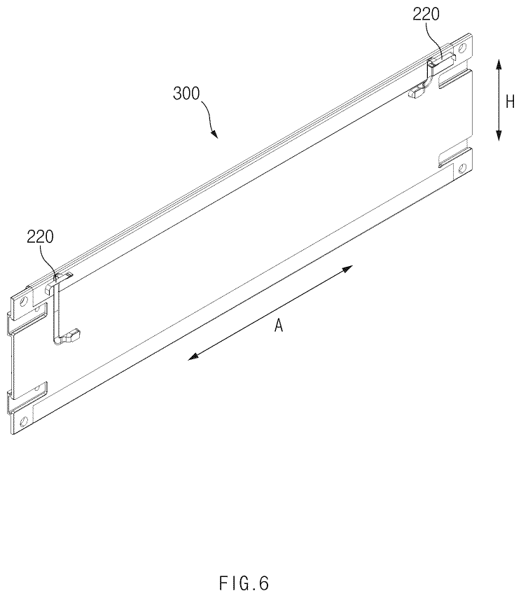

FIG. 5 is a perspective view of a side plate provided in the battery module according to the present disclosure. FIG. 6 is a view illustrating a state in which the temperature sensing part is seated in an accommodation groove formed in the side plate in FIG. 5.

As illustrated in FIGS. 1, 4, 5, and 6, the battery module 10 according to the present disclosure may further include side plates 300 provided at two opposite sides of the battery stack 100 with respect to the first axis or the leftward/rightward direction W. The side plates 300 may be configured to protect the battery stack 100 from the outside and fix the battery stack 100 so that an original shape of the battery stack 100 may be maintained. In this case, according to the present disclosure, the sensor member 220b and the foam member 220c may be inserted between the side plate 300 and the battery stack 100.

In addition, as illustrated in FIG. 4, the battery module 10 may further include surface pressure generation members 400 provided between the battery stack 100 and the side plates 300. In this case, according to the present disclosure, the surface pressure generation member 400 may be provided to overlap the sensor member 220b and the foam member 220c when the battery module 10 is viewed from one side with respect to the second axis or the forward/rearward direction A.

According to the present disclosure, at least a part of the temperature sensing part 220 may be provided to be seated on the side plate 300. More specifically, as illustrated in FIGS. 5 and 6, accommodation grooves 310 may be formed in an inner surface of the side plate 300, and a part of the connection member 220a may be accommodated in the accommodation groove 310. In this case, because the temperature sensing part 220 may be in contact with the end region of the battery stack based on the forward/rearward direction as described above, the accommodation groove 310 may be formed in an end region of the side plate 300 with respect to the second axis or the forward/rearward direction A.

Referring back to FIG. 1, the battery module 10 may further include end cap members 500 provided at one side of the battery stack 100 with respect to the second axis or the forward/rearward direction A, and a signal receiving board 600 fixed to one side of the end cap member 500 with respect to the second axis or the forward/rearward direction A. The signal receiving board 600 may be configured to receive signals related to (e.g., indicative of) temperatures and voltages measured by the temperature sensing part 220 and a substrate-busbar connection region described below.

More specifically, the substrate part 210 may further include a substrate-board connection region 216 having a shape extending forward from the end of the second substrate extension region 214 with respect to the second axis or the forward/rearward direction A and then bent downward. The substrate-board connection region 216 may be connected to the signal receiving board 600. Therefore, the signals related to (e.g., indicative of) temperatures and voltages may be transmitted to the signal receiving board 600 through the substrate-board connection region 216.

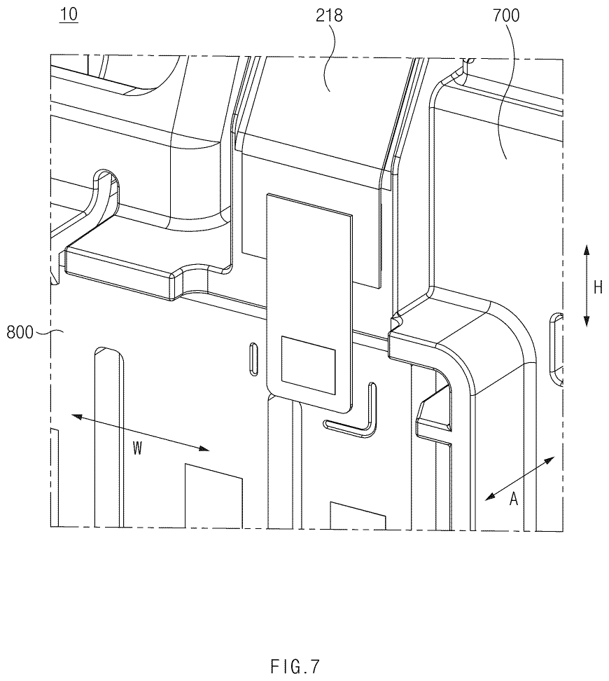

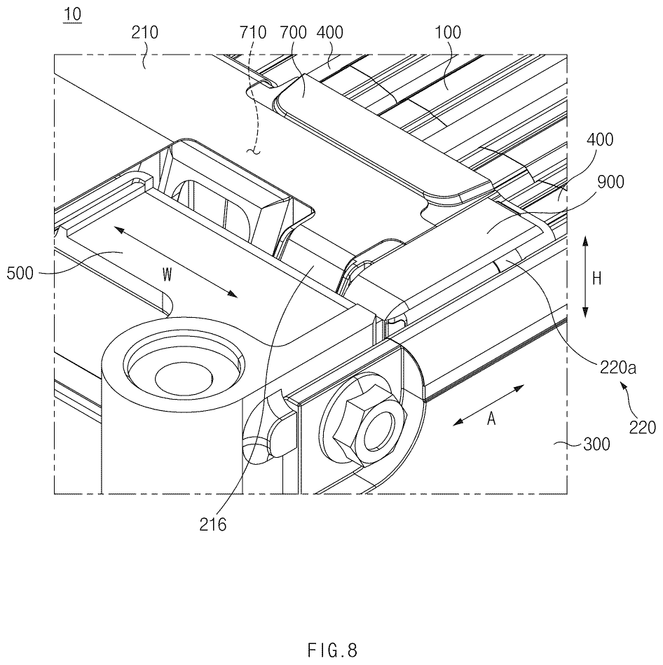

FIG. 7 is an enlarged view illustrating a connection structure between the sensing module and a busbar in the battery module according to the present disclosure. FIG. 8 is an enlarged view illustrating a region in which the substrate part and the temperature sensing part are connected and illustrating the surroundings of the region in the battery module according to the present disclosure.

As illustrated in FIG. 7, the battery module 10 according to the present disclosure may further include a holder member 700 provided at one side of the battery stack with respect to the second axis or the forward/rearward direction A, and a busbar 800 coupled to the holder member 700.

The substrate part may further include a substrate-busbar connection region 218 having a shape extending forward from the end of the second substrate extension region 214 (see FIG. 2 and the like) with respect to the second axis or the forward/rearward direction A and then bent downward. The substrate-busbar connection region 218 may be electrically connected to the busbar 800. The substrate-busbar connection region 218 may measure a voltage of the busbar 800, and a signal related to (e.g., indicative of) the measured voltage of the busbar 800 may be transmitted to the signal receiving board 600 through the substrate-busbar connection region 218.

In addition, as illustrated in FIG. 8, a seating groove 710 having a shape which is recessed downward may be formed in an upper surface of the holder member 700. A part of the second substrate extension region 214 may be seated in the seating groove 710. A length of the seating groove 710 along the second axis or in the forward/rearward direction A may correspond to a length along the second axis or in the forward/rearward direction A of a region of the second substrate extension region 214 seated in the seating groove 710. In this case, it is possible to effectively prevent the second substrate extension region 214 from separating from the holder member 700.

With continued reference to FIG. 8, the battery module may further include an insulation member 900 configured to cover a region in which the second substrate extension region 214 and the connection member 220a are in contact with each other. The insulation member 900 may be made of a material having electrical insulation. The insulation member 900 may be a tape member having electrical insulation.

The present disclosure has been described with reference to several embodiments and the drawings, but the present disclosure is not limited thereby. The present disclosure may be carried out in various forms by those of ordinary skill in the art to which the present disclosure pertains within the technical spirit of the present disclosure and the scope equivalent to the appended claims.

What is claimed is:

1. A battery module comprising:
a battery stack comprising a plurality of batteries stacked along a first axis; and
a sensing module coupled to a side of the battery stack,
wherein the sensing module comprises:
a substrate part provided above the battery stack; and
a temperature sensing part connected to a side of the substrate part and having a side provided to be in contact with the battery stack.

2. The battery module of claim 1, wherein the substrate part comprises:
a first substrate extension region extending along a second axis; and
a second substrate extension region connected to an end of the first substrate extension region with respect to the second axis and extending along the first axis, and
wherein the temperature sensing part is in contact with an end of the second substrate extension region with respect to the first axis.

3. The battery module of claim 2, wherein the first substrate extension region comprises a folded section having a shape folded along the second axis.

4. The battery module of claim 2, wherein the second substrate extension region comprises:
a first portion connected to a first end of the first substrate extension region with respect to the second axis and extending along the second axis; and
a second portion connected to a second end of the first substrate extension region with respect to the second axis and extending along the first axis, and
wherein the temperature sensing part comprises:
a first temperature sensing part provided to be in contact with an end of the first portion of the second substrate extension region with respect to the first axis; and
a second temperature sensing part provided to be in contact with an end of the second portion of the second substrate extension region with respect to the first axis.

5. The battery module of claim 4, wherein the first temperature sensing part comprises a first portion connected to one end of the first portion of the second substrate extension region with respect to the first axis,
wherein the second temperature sensing part comprises a first portion connected to one end of the second portion of the second substrate extension region with respect to the first axis, and
wherein a height along a third axis of a region in which the first portion of the first temperature sensing part is in contact with the battery stack is different from a height along the third axis of a region in which the first portion of the second temperature sensing part is in contact with the battery stack.

6. The battery module of claim 4, wherein the first temperature sensing part further comprises:
a first portion connected to a first end of the first portion of the second substrate extension region with respect to the first axis; and
a second portion connected to a second end of the first portion of the second substrate extension region with respect to the first axis, and
wherein a height along a third axis of a region in which the first portion of the first temperature sensing part is in contact with the battery stack is different from a height along the third axis of a region in which the second portion of the first temperature sensing part is in contact with the battery stack.

7. The battery module of claim 5, wherein the second temperature sensing part further comprises a second portion connected to a second end of the second part of the second substrate extension region with respect to the first axis, and
wherein a height along the third axis of a region in which the first portion of the second temperature sensing part is in contact with the battery stack is different from a height along the third axis of a region in which the second portion of the second temperature sensing part is in contact with the battery stack.

8. The battery module of claim 2, wherein the temperature sensing part further comprises:
a connection member provided to be partially in contact with an upper surface of the second substrate extension region;
a sensor member connected to one side of the connection member and provided to be in contact with the battery stack; and
a foam member at least partially provided outside the sensor member with respect to the first axis.

9. The battery module of claim 8, wherein the sensor member is embedded in the foam member.

10. The battery module of claim 8, further comprising:
side plates provided at two opposite sides of the battery stack with respect to the first axis,
wherein the sensor member and the foam member are inserted between the side plate and the battery stack.

11. The battery module of claim 10, further comprising:
a surface pressure generation member provided between the battery stack and the side plate,
wherein the surface pressure generation member is provided to overlap the sensor member and the foam member with respect to the second axis.

12. The battery module of claim 10, wherein an accommodation groove, which accommodates a part of the connection member, is formed in an inner surface of the side plate.

13. The battery module of claim 12, wherein the accommodation groove is formed in an end region of the side plate with respect to the second axis.

14. The battery module of claim 2, further comprising:
an end cap member provided at one side of the battery stack with respect to the second axis; and
a signal receiving board fixed to one side of the end cap member with respect to the second axis,
wherein the substrate part further comprises a substrate-board connection region having a shape extending forward from an end of the second substrate extension region with respect to the second axis and then bent downward, and
wherein the substrate-board connection region is connected to the signal receiving board.

15. The battery module of claim 2, further comprising:
a holder member provided at one side of the battery stack with respect to the second axis; and
a busbar coupled to the holder member,
wherein the substrate part further comprises a substrate-busbar connection region having a shape extending forward from an end of the second substrate extension region with respect to the second axis and then bent downward, and
wherein the substrate-busbar connection region is electrically connected to the busbar.

16. The battery module of claim 15, wherein a seating groove having a shape recessed downward is formed in an upper surface of the holder member, and
wherein a part of the second substrate extension region is seated in the seating groove.

17. The battery module of claim 8, further comprising:
an insulation member configured to cover a region in which the second substrate extension region and the connection member are in contact with each other.

18. The battery module of claim 1, wherein the substrate part is a flexible printed circuit board (FPCB).

19. A battery module comprising:
a battery stack comprising a plurality of batteries;
a sensing module coupled to a side of the battery stack, the sensing module including a substrate part and a temperature sensing part connected to a side of the substrate part and having a side in contact with the at least one of the plurality of batteries.

20. A battery module comprising:
a battery stack comprising a plurality of batteries; and
a sensing module coupled to a side of the battery stack, the sensing module comprising:
a substrate part including a first substrate extension region and a second substrate extension region connected to an end of the first substrate extension region and disposed perpendicular to the first substrate extension region; and
a temperature sensing part in contact with an end of the second substrate extension region and in contact with the battery stack.
